(19) United States
(12) Patent Application Publication
(10) Pub. No.: US 2026/0132262 A1
(43) Pub. Date: May 14, 2026

(54) BLACK POLYIMIDE FILM AND THE MANUFACTURING METHOD THEREOF

(71) Applicant: PI ADVANCED MATERIALS CO., LTD., Jincheon-gun, Chungcheongbuk-do (KR)

(72) Inventors: Moon Jin YEO, Jincheon-gun (KR); Jin seok JEON, Jincheon-gun (KR); Yun Seok CHAE, Jincheon-gun (KR); Dong Young WON, Jincheon-gun (KR)

(21) Appl. No.: 19/118,627

(22) PCT Filed: Sep. 26, 2023
(86) PCT No.: PCT/KR2023/014923

§ 371 Date: Apr. 4, 2025

(30) Foreign Application Priority Data
Oct. 4, 2022 (KR) 10-2022-0126241

(51) Int. Cl. C08J 5/18; C08G 73/10; C08K 3/04

(52) U.S. Cl. CPC C08J 5/18; C08G 73/10; C08K 3/04; C08K 2201/003; C08K 2201/014

(57) ABSTRACT

The present invention provides a black polyimide film manufactured by imidizing a polyamic acid obtained from dianhydride monomers and diamine monomers, the black polyimide film comprising: a black pigment containing bituminous coal and perylene black.

### TECHNICAL FIELD

The present invention relates to a black polyimide film and a manufacturing method thereof, and more particularly, to a low-k, low-gloss, and low-transmittance black polyimide film containing a black pigment, and a manufacturing method thereof.

### BACKGROUND ART

Polyimide is a general term for polymers having an imide structure, and is generally manufactured by condensation reaction of aromatic acid anhydride and aromatic diamine, and has excellent properties such as high thermal resistance which is the property of enduring from cryogenic temperatures to high temperatures of 400° C. or higher, electrical insulation, radiation resistance, and chemical resistance, etc., and thus it is used in a wide range of fields as high-tech materials and insulating coatings, for example, in the fields of electric and electronic, semiconductor, display, automobile, aviation, and space materials.

However, since the polyimide has “insoluble, infusible” characteristics which is not soluble in solvents and is not able to be molded by heating, the use of polyimide has been limited. Thus, most polyimides are manufactured by processing polyamic acid, a precursor, followed by heat treatment at a high temperature and a curing imidization process, and a typical product manufactured in this way is a polyimide film.

Recently, the polyimide is widely used as a coverlay for portable electronic devices and communication devices. Coverlay is used to protect electronic components such as lead frames of printed wiring boards, semiconductor integrated circuits, etc., and requires physical properties such as thinning and slimming, etc., and recently also requires optical properties as well as security, portability, visual effects, and concealment of electronic or mounted components.

In general, both matting agents and color additives (for example, pigments or dyes) are used in manufacturing polyimide films. In the conventional manufacturing processes, color additives (such as carbon black) are usually contained to reduce the transparency of the polyimide film, while matting agents such as SiO₂ may be added to reduce the gloss of the polyimide film. However, neither the color additive nor the matting agent alone may not achieve matting property and reduce transparency. Accordingly, conventional manufacturing processes require the use of large amounts of color additives and matting agents to impart desired properties to polyimide films, which not only causes problems such as difficulty in handling and poor dispersion of additives, but also produces high permittivity and high dielectric dissipation factor, making it difficult to internalize in 5G electronic devices.

Therefore, there is a need to develop a black polyimide film for high-speed transmission comprising an optimal combination of black pigments to implement a polyimide film having low permittivity and low dielectric dissipation factor, low gloss, and transmittance even without adding a matting agent.

### DISCLOSURE OF INVENTION

### Technical Problem

An object of the present invention is to provide a black polyimide film comprising a black pigment having a controlled particle diameter on polyimide, having excellent optical properties such as gloss and transmittance, and having a low permittivity (dielectric constant) and a low dielectric dissipation factor.

In addition, another object of the present invention is to provide a manufacturing method of the black polyimide film.

Further, still another object of the present invention is to provide a coverlay comprising the black polyimide film.

In addition, still another object of the present invention is to provide an electronic device for high-speed transmission comprising the coverlay.

### Solution to Problem

Hereinafter, exemplary embodiments of the present invention will be described in more detail in the order of “black polyimide film” and “manufacturing method of black polyimide film” according to the present invention.

Various modifications can be made and various embodiments may be implemented in the present invention, and specific embodiments are described in detail. However, these embodiments are not intended to limit the present invention to specific embodiments, and should be understood to comprise all modifications, equivalents, and substitutes included in the spirit and scope of the present invention.

Terms used in the present application are only used to describe specific embodiments and are not intended to limit the present invention. Singular expressions include plural expressions unless the context clearly indicates otherwise. In the present specification, terms such as “comprise” or “have” are intended to designate the presence of features, numbers, steps, operations, components, parts, or combinations thereof described in the specification and it should not be understood as precluding the possibility of the presence or addition of one or more other features, numbers, steps, operations, components, parts, or combinations thereof.

When amounts, concentrations, or other values or parameters herein are given as ranges, preferred ranges, or lists of upper desirable values and lower desirable values, it should be understood as specifically disclosing all ranges formed by any pair of any upper range limit or preferred value and any lower range limit or preferred value, regardless of whether the scope is separately disclosed.

Where ranges of numerical values are stated herein, unless otherwise stated, it is intended that the endpoints of the range and the scope of the parent invention within the range are not limited to the specific values stated when defining the range.

As used herein, “dianhydride” is intended to include precursors or derivatives thereof, which are also referred to as “dianhydride” or “acid dianhydride”. These products may technically not be dianhydrides, but will nonetheless react with diamine to form a polyamic acid, and the polyamic acid may be converted back into polyimide.

As used herein, “diamine” is intended to include precursors or derivatives thereof, which may technically not be diamines, but will nonetheless react with dianhydride acid to form a polyamic acid, and the polyamic acid may be converted back into polyimide.

Further, unless defined otherwise, all terms used herein, including technical or scientific terms, have the same meaning as commonly understood by one of ordinary skill in the art to which the present invention belongs. Terms such as those defined in commonly used dictionaries should be interpreted as having a meaning consistent with the meaning in the context of the related art, and unless explicitly defined in the present application, it is not to be construed in an idealized or overly formal sense. Specific details for the implementation of the invention will be described below.

### Black Polyimide Film

The present invention provides a black polyimide film manufactured by imidizing a polyamic acid obtained from dianhydride monomers and diamine monomers, the black polyimide film comprising: a black pigment containing bituminous coal and perylene black.

The bituminous coal is also called soft coal, and is black or dark black coal with a glass luster or a resin luster, having a high content of volatile substances. In the present invention, the bituminous coal may contain up to 20% of volatile substances and about 75% of fixed carbon, but the present invention is not limited thereto. In addition, the bituminous coal may contain up to 1% of moisture, up to 0.9% of SO₂, and about 7.5% of ash. The polyimide film of the present invention may contain bituminous coal to reduce gloss.

As bituminous coal, for example, Mineral Black 325 BA (Keystone Filley & Mfg.Co.), Austin Black 325 (Coal Fillers Inc.), or a combination thereof may be used. In the embodiment of the present invention, Austin Black 325 from Coal Fillers Inc., was used.

Perylene black pigment is one of black organic pigments that exhibit a black color by absorbing light in the wavelength range of visible light having a perylene structure in a molecule.

Examples of the perylene black may include Pigment Black 31 and Pigment Black 32 [each number identified in the Color Index (C.I.)], in addition thereto, may include BASF's PALIOGEN® BLACK S0084, PALIOGEN® K0084, PALIOGEN® L0086, PALIOGEN® K0086, PALIOGEN® EH0788, PALIOGEN® FK4281, Lumogen® Black K 0087, etc. In an embodiment, Lumogen® Black K 0087 was used as the perylene black.

In the present invention, the film may contain 5 to 30% by weight of the black pigment based on the total weight of the film. Preferably, the film may contain the black pigment in an amount of 5% by weight or more, 6% by weight or more, 7% by weight or more, 8% by weight or more, 9% by weight or more, 10% by weight or more, 11% by weight or more, 12% by weight or more, 13% by weight or more or 14% by weight or more, wherein the upper limit thereof may be 30% by weight or less, 29% by weight or less, 28% by weight or less, 27% by weight or less, 26% by weight or less, 25% by weight or less, 24% by weight or less, 23% by weight or less, 22% by weight or less, 21% by weight or less, 20% by weight or less, 19% by weight or less, 18% by weight or less, or 17% by weight or less. When the amount of the black pigment in the film is less than 5% by weight, light transmittance is increased, and when the amount thereof is more than 30% by weight, dispersibility and physical properties of the film are deteriorated.

In the present invention, the film may comprise 3 to 15% by weight of bituminous coal and 2 to 15% by weight of perylene black based on the total weight of the film.

For example, the bituminous coal may be contained in an amount of 3% by weight or more, 3.5% by weight or more, 4% by weight or more, 4.5% by weight or more, 5% by weight or more, 5.5% by weight or more, 6% by weight or more, or 6.5% by weight or more, wherein the upper limit thereof may be 10% by weight or less, 9% by weight or less, 8% by weight or less, or 7% by weight or less. When bituminous coal is used in excess of 15% by weight, it is not effective in lowering the transmittance.

Further, in an embodiment, the perylene black may be contained in an amount of 2% by weight or more, 2.5% by weight or more, 3% by weight or more, 3.5% by weight or more, 4% by weight or more, 4.5% by weight or more, 5% by weight or more, 5.5% by weight or more, 6% by weight or more, 6.5% by weight or more, 7% by weight or more, or 7.5% by weight or more, wherein the upper limit thereof may be 10% by weight or less, 9.5% by weight or less, 9% by weight or less, 8.5% by weight or less, or 8% by weight or less. When the perylene black has an amount of less than 2% by weight, it is not effective in lowering the transmittance.

In the present invention, gloss, transmittance, dielectric constant, and dielectric dissipation factor may be maintained at a lower level by including a black pigment containing bituminous coal and perylene black.

In the present invention, the bituminous coal may have an average particle diameter (D50) of 0.5 to 10 μm, preferably 1 to 8 μm, and more preferably 2 to 5 μm. In addition, the bituminous coal may have an average particle diameter (D10) of 0.5 to 2 μm and an average particle diameter (D90) of 3 to 7 μm. The average particle diameter of bituminous coal may indicate an average particle diameter after milling. When the range of average particle diameter (D50) is more than 10 μm, surface properties of the film may be damaged, dispersibility thereof may be deteriorated, and mechanical properties of the film may be deteriorated.

In the present invention, the perylene black may have an average particle diameter (D50) of 100 nm to 1,200 nm, specifically 200 nm to 1000 nm, and more specifically 300 nm to 900 nm. When the range of average particle diameter (D50) is more than 1200 nm, surface properties of the film may be damaged, dispersibility thereof may be deteriorated, and mechanical properties of the film may be deteriorated. In addition, the perylene black may have an average particle diameter (D10) of 100 to 400 nm, and an average particle diameter (D90) of 500 to 2000 nm. The average particle diameter of perylene black may indicate an average particle diameter after milling.

According to the present invention, a black polyimide film having low gloss, transparency, dielectric constant and dielectric dissipation factor is implemented by adjusting the particle diameter of the black pigment to an appropriate size through milling.

In the present invention, the dianhydride monomer may be at least one selected from the group consisting of pyromellitic dianhydride (PMDA), oxydiphthalic dianhydride (ODPA), 3, 3′, 4,4′-biphenyltetracarboxylic dianhydride (s-BPDA), 2,3, 3′, 4′-biphenyltetracarboxylic dianhydride (a-BPDA), diphenylsulfone-3, 4, 3′, 4′-tetracarboxylic dianhydride (DSDA), bis(3,4-dicarboxyphenyl) sulfide dianhydride, 2,2-bis(3,4-dicarboxyphenyl)-1, 1, 1, 3, 3, 3-hexafluoropropane dianhydride, 2, 3, 3′, 4′-benzophenone tetracarboxylic dianhydride, 3,3′, 4, 4′-benzophenonetetracarboxylic dianhydride (BTDA), bis(3,4-dicarboxyphenyl) methane dianhydride, 2,2-bis(3,4-dicarboxyphenyl)propane dianhydride, p-phenylenebis(trimellitic monoester acid anhydride), p-biphenylenebis(trimellitic monoester acid anhydride), m-terphenyl-3, 4, 3′, 4′-tetracarboxylic dianhydride, p-terphenyl-3, 4, 3′, 4′-tetracarboxylic dianhydride, 1, 3-bis(3, 4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3, 6, 7-naphthalene tetracarboxylic acid dianhydride, 1,4,5,8-naphthalenetetracarboxylic dianhydride and 4,4′-(2,2-hexafluoroisopropylidene)diphthalic acid dianhydride, and specifically, may be at least one selected from the group consisting of pyromellitic dianhydride (PMDA), oxydiphthalic dianhydride (ODPA), 3, 3′, 4, 4′-biphenyltetracarboxylic dianhydride (s-BPDA), 2, 3, 3′, 4′-biphenyltetracarboxylic dianhydride (a-BPDA), and 3, 3′, 4, 4′-benzophenonetetracarboxylic dianhydride (BTDA), and more specifically, may be at least one selected from the group consisting of pyromellitic dianhydride (PMDA), 3,3′, 4, 4′-biphenyltetracarboxylic dianhydride (s-BPDA), 2,3, 3′, 4′-biphenyltetracarboxylic dianhydride (a-BPDA) and 3, 3′,4,4′-benzophenonetetracarboxylic dianhydride (BTDA).

Further, the diamine monomer may be at least one selected from the group consisting of paraphenylenediamine (PPD), metaphenylenediamine, 3,3′-dimethylbenzidine, 2,2′-dimethylbenzidine, 2,4-diaminotoluene, 2, 6-diaminotoluene, 3,5-diaminobenzoic acid (DABA), 4,4′-oxydianiline (ODA), 4,4′-diaminodiphenylmethane, 3,3′-dimethyl-4,4′-diaminobiphenyl, 2,2′-dimethyl-4,4′-diaminobiphenyl(m-tolidine), 2,2′-bis(trifluoromethyl)-4, 4′-diaminobiphenyl, 3,3′-dimethyl-4,4′-diaminodiphenylmethane, 3,3′-dicarboxy-4, 4′-diaminodiphenylmethane, 3, 3′, 5, 5′-tetramethyl-4,4′-diaminodiphenylmethane, bis(4-aminophenyl) sulfide, 4,4′-diaminobenzanilide, 3,3′-dimethoxybenzidine, 2,2′-dimethoxybenzidine, 3,3′-diaminodiphenyl ether, 3,4′-diaminodiphenyl ether, 4,4′-diaminodiphenyl ether, 3,3′-diaminodiphenylsulfide, 3, 4′-diaminodiphenylsulfide, 4,4′-diaminodiphenylsulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,3′-diamino-4, 4′-dichlorobenzophenone, 3,3′-diamino-4, 4′-dimethoxybenzophenone, 3, 3′-diaminodiphenylmethane, 3, 4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1, 1, 1, 3, 3, 3-hexafluoropropane, 2,2-bis(4-aminophenyl)-1, 1, 1, 3, 3, 3-hexafluoropropane, 3,3′-diaminodiphenylsulfoxide, 3,4′-diaminodiphenylsulfoxide, 4,4′-diaminodiphenylsulfoxide, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene (TPE-R), 1,4-bis(3-aminophenoxy)benzene (TPE-Q), 1,3-bis(3-aminophenoxy)-4-trifluoromethylbenzene, 3,3′-diamino-4-(4-phenyl) phenoxybenzophenone, 3,3′-diamino-4, 4′-di(4-phenylphenoxy)benzophenone, 1,3-bis(3-aminophenylsulfide)benzene, 1, 3-bis(4-aminophenylsulfide)benzene, 1,4-bis(4-aminophenylsulfide)benzene, 1,3-bis(3-aminophenylsulfone)benzene, 1, 3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, 3,3′-bis(3-aminophenoxy)biphenyl, 3, 3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2, 2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane (BAPP), 2,2-bis[3-(3-aminophenoxy)phenyl]-1, 1, 1, 3, 3, 3-hexafluoropropane, 2,2-bis[3-(4-aminophenoxy)phenyl]-1, 1, 1, 3, 3, 3-hexafluoropropane, 2,2-bis[4-(3-aminophenoxy)phenyl]-1, 1, 1, 3, 3, 3-hexafluoropropane and 2, 2-bis[4-(4-aminophenoxy)phenyl]-1, 1, 1, 3, 3, 3-hexafluoropropane, and specifically, may be at least one selected from the group consisting of paraphenylenediamine (PPD), 2,2′-dimethyl-4,4′-diaminobiphenyl(m-tolidine), 4,4′-oxydianiline (ODA), and 1, 3-bis(4-aminophenoxy)benzene (TPE-R), and more specifically, may be paraphenylenediamine (PPD) and 2, 2′-dimethyl-4,4′-diaminobiphenyl(m-tolidine).

In an embodiment, the polyamic acid includes, as polymerization units, a mixture of dianhydride monomers including pyromellitic dianhydride (PMDA), 3,3′, 4, 4 ‘-biphenyltetracarboxylic dianhydride (s-BPDA), 2, 3, 3’, 4′-biphenyltetracarboxylic dianhydride (a-BPDA) and 3,3′, 4, 4 ‘-benzophenonetetracarboxylic dianhydride (BTDA), and diamine monomers including para-phenylenediamine (PPD) and 2, 2’-dimethyl-4, 4′-diaminobiphenyl(m-tolidine).

Here, pyromellitic dianhydride (PMDA) may be contained in an amount of 20 mol % or more to 80 mol % or less of the total dianhydride monomer components, and preferably may be contained in an amount of 22 mol % or more, 24 mol % or more, 26 mol % or more, 28 mol % or more, 30 mol % or more, 31 mol % or more, 32 mol % or more, 33 mol % or more, 34 mol % or more, 35 mol % or more, 36 mol % or more, 37 mol % or more, 38 mol % or more, 39 mol % or more, or 40 mol % or more, wherein the upper limit thereof may be 80 mol % or less, 75 mol % or less, 70 mol % or less, 65 mol % or less, 60 mol % or less, 55 mol % or less, 50 mol % or less, 48 mol % or less, 46 mol % or less, 44 mol % or less, 42 mol % or less, 40 mol % or less, 39 mol % or less, 38 mol % or less, 37 mol % or less, 36 mol % or less, 35 mol % or less, 34 mol % or less, 33 mol % or less, 32 mol % or less, 31 mol % or less, or 30 mol % or less.

In addition, 3, 3′, 4, 4′-benzophenonetetracarboxylic dianhydride (BTDA) may be contained in an amount of 10 mol % or more to 50 mol % or less of the total dianhydride monomer components, and preferably may be contained in an amount of 10 mol % or more, 15 mol % or more, 20 mol % or more, 22 mol % or more, 24 mol % or more, 26 mol % or more, 28 mol % or more, 30 mol % or more, 31 mol % or more, 32 mol % or more, 33 mol % or more, 34 mol % or more, 35 mol % or more, 36 mol % or more, 37 mol % or more, 38 mol % or more, 39 mol % or more, or 40 mol % or more, wherein the upper limit thereof may be 50 mol % or less, 48 mol % or less, 46 mol % or less, 44 mol % or less, 42 mol % or less, 40 mol % or less, 39 mol % or less, 38 mol % or less, 37 mol % or less, 36 mol % or less, 35 mol % or less, 34 mol % or less, 33 mol % or less, 32 mol % or less, 31 mol % or less, or 30 mol % or less.

In addition, 2, 3, 3′, 4′-biphenyltetracarboxylic dianhydride (a-BPDA) or 3, 3′, 4, 4′-biphenyltetracarboxylic dianhydride (s-BPDA) may be contained in an amount of 10 mol % or more to 50 mol % or less of the total dianhydride monomer components, and preferably may be contained in an amount of 10 mol % or more, 15 mol % or more, 20 mol % or more, 22 mol % or more, 24 mol % or more, 26 mol % or more, 28 mol % or more, 30 mol % or more, 31 mol % or more, 32 mol % or more, 33 mol % or more, 34 mol % or more, 35 mol % or more, 36 mol % or more, 37 mol % or more, 38 mol % or more, 39 mol % or more, or 40 mol % or more, wherein the upper limit thereof may be 50 mol % or less, 48 mol % or less, 46 mol % or less, 44 mol % or less, 42 mol % or less, 40 mol % or less, 39 mol % or less, 38 mol % or less, 37 mol % or less, 36 mol % or less, 35 mol % or less, 34 mol % or less, 33 mol % or less, 32 mol % or less, 31 mol % or less, or 30 mol % or less.

In the present invention, the polyamic acid may be prepared by properly adjusting amounts of dianhydride components within the range in which the dianhydride components are 100 mol % in total, the dianhydride components comprising: pyromellitic dianhydride (PMDA), 3, 3′, 4, 4′-biphenyltetracarboxylic dianhydride (s-BPDA), 2, 3, 3′, 4′-biphenyltetracarboxylic dianhydride (a-BPDA), and 3, 3′, 4, 4′-benzophenonetetracarboxylic dianhydride (BTDA).

In an embodiment, the dianhydride monomer may contain 20 to 80 mol % of pyromellitic dianhydride (PMDA); 10 to 50 mol % of 3,3′, 4, 4′-biphenyltetracarboxylic dianhydride (s-BPDA) or 2,3,3′, 4′-biphenyltetracarboxylic dianhydride (a-BPDA); and 10 to 50 mol % of 3, 3′, 4, 4′-benzophenonetetracarboxylic dianhydride (BTDA).

In addition, the paraphenylenediamine (PPD) may be contained in an amount of 10 mol % or more to 80 mol % or less of the total diamine monomer components, and preferably may be contained in an amount of 10 mol % or more, 15 mol % or more, 20 mol % or more, 25 mol % or more, 30 mol % or more, 35 mol % or more, 40 mol % or more, 42 mol % or more, 44 mol % or more, 46 mol % or more, 48 mol % or more, 50 mol % or more, 52 mol % or more, 54 mol % or more, 56 mol % or more, 58 mol % or more, 60 mol % or more, 62 mol % or more, 64 mol % or more, 66 mol % or more, 68 mol % or more, 70 mol % or more, 72 mol % or more, 74 mol % or more, or 76 mol % or more, wherein the upper limit thereof may be 80 mol % or less, 78 mol % or less, 76 mol % or less, 74 mol % or less, 72 mol % or less, 70 mol % or less, 68 mol % or less, 66 mol % or less, 64 mol % or less, 62 mol % or less, 60 mol % or less, 55 mol % or less, 50 mol % or less, or 45 mol % or less.

Further, 2,2′-dimethyl-4,4′-diaminobiphenyl(m-tolidine) may be contained in an amount of 20 mol % or more to 90 mol % or less of the total diamine monomer components, and preferably may be contained in an amount of 22 mol % or more, 24 mol % or more, 26 mol % or more, 28 mol % or more, 30 mol % or more, 31 mol % or more, 32 mol % or more, 33 mol % or more, 34 mol % or more, 35 mol % or more, 36 mol % or more, 37 mol % or more, 38 mol % or more, 39 mol % or more, or 40 mol % or more, wherein the upper limit thereof may be 90 mol % or less, 88 mol % or less, 86 mol % or less, 84 mol % or less, 82 mol % or less, 80 mol % or less, 78 mol % or less, 76 mol % or less, 74 mol % or less, 72 mol % or less, 70 mol % or less, 68 mol % or less, 66 mol % or less, 64 mol % or less, 62 mol % or less, 60 mol % or less, 58 mol % or less, 56 mol % or less, 54 mol % or less, 52 mol % or less, 50 mol % or less, 48 mol % or less, 46 mol % or less, 44 mol % or less, 42 mol % or less, 40 mol % or less, 39 mol % or less, 38 mol % or less, 37 mol % or less, 36 mol % or less, or 35 mol % or less.

In the present invention, the polyamic acid may be prepared by properly adjusting amounts of respective diamine monomer components within the range in which the diamine monomer components are 100 mol % in total, the diamine monomer components comprising: paraphenylenediamine (PPD) and 2, 2′-dimethyl-4,4′-diaminobiphenyl(m-tolidine).

In an embodiment, the diamine monomer contains 10 to 80 mol % of paraphenylenediamine (PPD); and 20 to 90 mol % of 2,2′-dimethyl-4,4′-diaminobiphenyl(m-tolidine).

In the present invention, a molar ratio of the diamine monomer to the dianhydride monomer may be 0.5 to 2 equivalents. Specifically, the molar ratio may be 0.8 to 1.5 equivalents. When the molar ratio is less than 0.5 equivalents or more than 2 equivalents, the polyimide that is finally formed has a very low molecular weight, and thus there is a problem that the physical and chemical properties are very poor.

The black polyimide film according to the present invention may have a thickness of 3 to 100 μm, specifically 4 to 90 μm, more specifically 5 to 80 μm, and more specifically, 5.5 to 50 μm. A thickness of the film is not particularly limited as long as the film is capable of being flexibly applied, and the thickness may be adjusted in consideration of mechanical strength, handling, productivity, and the like.

The black polyimide film of the present invention may have a transmittance of 0.2% or less in the visible light region, a gloss (60°) of 50 or less, a dielectric constant (Dk) of 4.0 or less, and a dielectric dissipation factor (Df) of 0.01 or less.

Further, the black polyimide film of the present invention may have a transmittance of 0.1% or less in the visible light region, a gloss (60°) of 40 or less, a dielectric constant (Dk) of 3.7 or less, and a dielectric dissipation factor (Df) of 0.01 or less.

Further, the black polyimide film of the present invention may simultaneously satisfy the conditions that the transmittance in the visible light region is 0.2% or less, the gloss (60°) is 50 or less, the dielectric constant (Dk) is 4.0 or less, and the dielectric dissipation factor (Df) is 0.01 or less.

In addition, the black polyimide film of the present invention may simultaneously satisfy the conditions that the transmittance in the visible light region is 0.1% or less, the gloss (60°) is 40 or less, the dielectric constant (Dk) is 3.7 or less, and the dielectric dissipation factor (Df) is 0.01 or less.

The black polyimide film according to the present invention, for example, may have a dielectric constant at 10 GHZ of 4.0 or less, preferably 3.9 or less, more preferably 3.7 or less, wherein the lower limit thereof may be at least 3.0 or more. It may be appreciated that an ideal permittivity as an insulator is shown when considering that the polyimide film has the highest engineering characteristics.

In addition, the black polyimide film according to the present invention may have, for example, the dielectric dissipation factor (Df) at 10 GHz of 0.01 or less, preferably 0.0099 or less, wherein the lower limit thereof may be at least 0.005 or more. Term “dielectric dissipation factor” refers to the force dissipated by a dielectric (or insulator) when the friction between molecules interferes with the molecular motion caused by alternating electric fields, and the value of dielectric dissipation factor is commonly used as an index indicating the ease of charge loss (dielectric loss). The higher the dielectric dissipation factor, the easier it is for charges to be lost, and conversely, the lower the dielectric dissipation factor, the more difficult it is for charges to be lost. In other words, the dielectric dissipation factor is a measure of power loss. As the dielectric dissipation factor is lower, signal transmission delay due to power loss may be alleviated and communication speed may be maintained to be high.

Therefore, the polyimide film of the present invention has an advantage in that it is easy to maintain insulation even in electronic devices for high-speed transmission that operate at a high frequency of giga units, for example, 10 GHz or higher.

In addition, the black polyimide film according to the present invention, as an example, may have a transmittance of 0.2% or less, and preferably 0.10 or less. It may be appreciated that the film has physical properties suitable for use as a cover lay.

In addition, the black polyimide film according to the present invention may have a gloss (60°) of 50 or less, preferably 45 or less, more preferably 40 or less, and even more preferably 37 or less. If the gloss exceeds 50, there may be problems with poor visual aesthetics and poor cover function.

Accordingly, the polyimide film that satisfies all of the dielectric constant, dielectric dissipation factor, gloss, and transmittance may be utilized as an insulating film for coverlay, and even if the manufactured coverlay is used as an electrical signal transmission circuit that transmits signals at a high frequency of 10 GHz or more, it is possible to ensure insulation stability and minimize signal transmission delay.

The black polyimide film of the present invention that simultaneously satisfies the conditions in which transmittance in the visible light region is 0.2% or less, gloss (60°) is 50 or less, dielectric constant (Dk) is 4.0 or less, and dielectric dissipation factor (Df) is 0.01 or less is a novel black polyimide film that is unknown so far.

### Manufacturing Method of Black Polyimide Film of Present Invention

The present invention provides a manufacturing method of a black polyimide film comprising as follows:
(1) polymerizing a polyamic acid solution from at least one dianhydride monomer and at least one diamine monomer;
(2) preparing a polyimide precursor composition by mixing the polyamic acid solution with a black pigment containing bituminous coal and perylene black; and
(3) imidizing the polyimide precursor composition by forming a film on a support and heat-treating the film.

In the manufacturing method of the black polyimide film, the “dianhydride monomer” and the “diamine monomer” are the same as described above, and the manufacturing method of the black polyimide film of the present invention may generally be a method for forming a polyimide film.

In an embodiment, in Step (1), the polyamic acid solution is obtained by reacting the dianhydride and diamine using an organic solvent. Here, the solvent is not particularly limited as long as the polyamic acid is capable of being dissolved, but may be an aprotic polar solvent as an example. Preferably, N-methyl-pyrrolidone (NMP), N,N′-dimethylformamide (DMF), N,N′-diethylformamide (DEF), N,N′-dimethylacetamide (DMAC), dimethylpropanamide (DMPA), N, N-diethylacetamide (685-91-6, DEAc), 3-methoxy-N, N-dimethylpropanamide (53185-52-7, KJCMPA), etc., may be used alone or in combination, but most preferably N-methyl-pyrrolidone (NMP) may be used.

In the present invention, the weight average molecular weight of the polyamic acid solution of the present invention may be 100,000 g/mol to 300,000 g/mol. The lower limit of the weight average molecular weight may be 100,000 g/mol or more, 120,000 g/mol or more, 150,000 g/mol or more, or 200,000 g/mol or more, and the upper limit of the weight average molecular weight may be 300,000 g/mol or less, 280,000 g/mol or less, 270,000 g/mol or less, 260,000 g/mol or less, or 250,000 g/mol or less.

In the present invention, the weight of the monomers added in the total polyamic acid solution when substantially equimolar amounts of diamine and dianhydride are added is referred to as the solid content, and the polyamic acid solution may have a solid content of 5 to 30% by weight. The lower limit of the percent (%) by weight of the solid content may be 5% by weight or more, 8% by weight or more, 9% by weight or more, 10% by weight or more, 15% by weight or more, 20% by weight or more, 21% by weight or more, 22% by weight or more, 23% by weight or more, 24% by weight or more, 25% by weight or more, 26% by weight or more, 27% by weight or more, 28% by weight or more, or 29% by weight or more, and the upper limit of the percent (%) by weight of the solid content may be 29% by weight or less, 27% by weight or less, 25% by weight or less, 23% by weight or less, 21% by weight or less, 20% by weight or less, 19% by weight or less, or 18% by weight or less. By adjusting the solid content of the polyamic acid composition, it is possible to control the increase in viscosity and to shorten the processing time during the curing process.

In the present invention, the polyamic acid solution may have a viscosity in the range of 20,000 to 400,000 cP, the viscosity being measured at a temperature of 23° C. and a shear rate of 1s-1. For example, the upper limit of the viscosity may be 400,000 cP or less, 350,000 cP or less, 300,000 cP or less, or 250,000 cP or less. The lower limit of the viscosity is not particularly limited, but may be 20,000 cP or more, 30,000 cP or more, 40,000 cP or more, 50,000 cP or more, 60,000 cP or more, or 80,000 cP or more. The viscosity may be measured using, for example, Haake's Rheostress 600 and may be measured under the conditions of a shear rate of 1/s, a temperature of 23° C., and a plate gap of 1 mm. The present invention may provide a precursor composition with excellent processability by adjusting the viscosity range.

In Step (2), the bituminous coal and perylene black contained in the polyimide precursor composition are milled through a milling process to adjust the particle diameters, thereby increasing the degree of dispersion so that the components are mixed uniformly when mixed with the polyamic acid solution, while simultaneously lowering gloss, transmittance, dielectric constant, and dielectric dissipation factor.

Regarding this, the manufacturing method may further comprise, before Step (2), milling with a milling machine to prepare bituminous coal having an average particle diameter (D50) of 0.5 to 10 μm and perylene black having an average particle diameter (D50) of 100 to 1200 nm, respectively.

In an embodiment, the milling process may be performed to prepare bituminous coal and/or perylene black each having a particle diameter in the range described above using a bead mill with beads having a particle diameter of 1.0 to 2.0 mm, and the milling process may be performed by treating bituminous coal and perylene black individually or by treating bituminous coal and perylene black together. The stirring speed and milling time during the milling process may be appropriately adjusted depending on the desired particle diameter, which are not particularly limited. In addition, bituminous coal and/or perylene black each having a particle diameter in the range described above may be prepared by performing milling using a bead mill with beads having a particle diameter of 0.8 to 1.5 mm.

In addition, in Step (2), the black pigment is obtained by dispersing bituminous coal and perylene black in an organic solvent, wherein the organic solvent may be at least one selected from the group consisting of N-methylformamide, N,N′-dimethylformamide (DMF), N-methylformanilide, N,N′-dimethylacetamide (DMAC), N-methyl-pyrrolidone (NMP), propylene glycol methyl ether acetate (PGMEA), ethyl glycol acetate, propylene glycol monomethyl ether acetate, dimethyl sulfoxide, benzyl ethyl ether, dihexyl ether, and acetylacetone, and preferably may be at least one selected from the group consisting of N,N′-dimethylformamide (DMF), N,N′-dimethylacetamide (DMAC), N-methyl-pyrrolidone (NMP) and propylene glycol methyl ether acetate (PGMEA).

In the present invention, Step (3) may be performed by casting the polyimide precursor composition prepared in Step (2) on a support and drying to form a gel film, and then imidizing the gel film to form a black polyimide film.

The forming of the gel film may be performed by casting the polyimide precursor composition in a film form on a support such as aluminum foil, an endless stainless steel belt, a stainless drum, or the like, and then drying the precursor composition on the support at 50° C. to 200° C., specifically, at a variable temperature ranging from 80° C. to 150° C.

The imidization may be performed through heat treatment, wherein the heat treatment may be performed at a variable temperature ranging from 50° C. to 500° C., specifically 150° C. to 500° C. to remove remaining water, residual solvent, etc., and imidize almost all remaining amic acid groups, thereby manufacturing the black polyimide film of the present invention. In some cases, the polyimide film obtained as above may be heated and finished at a temperature of 400° C. to 650° C. for 5 to 400 seconds to further cure the polyimide film, and the polyimide film may be treated under a certain tension in order to relieve internal stress that may remain in the obtained polyimide film.

The present invention provides a coverlay comprising the black polyimide film and an electronic device for high-speed transmission comprising the coverlay.

### Advantageous Effects of Invention

The black polyimide film of the present invention comprises a black pigment containing a combination of bituminous coal and black perylene to have excellent optical properties such as low gloss and low transmittance, and have excellent low dielectric properties due to a low permittivity (dielectric constant) and a low dielectric dissipation factor.

### BEST MODE FOR CARRYING OUT THE INVENTION

The following are Examples presented to help understanding of the present invention. The following examples are only provided to more easily understand the present invention, but the content of the present invention is not limited by these Examples.

### EXAMPLE

### Example 1: Preparation of Polyimide Precursor Composition

### Example 1-1

As a polyamic acid solution polymerization process, 408.62 g of dimethylformamide (DMF) as a solvent was added to a 500 mL reaction vessel under a nitrogen atmosphere. A temperature was set to 25° C., PPD (66 mol %) and m-tolidine (34 mol %) were added as diamine monomers, stirred for about 30 minutes to confirm that the monomers were dissolved, and then PMDA (35 mol %), BTDA (33 mol %), and BPDA (32 mol %) were added as dianhydride monomers, and stirred to react until there was no change in viscosity, thereby obtaining a polyamic acid solution.

A polyimide precursor composition was prepared by mixing the prepared polyamic acid solution with a black pigment containing bituminous coal (6.6% by weight) and perylene black (3.5% by weight) dispersed in an organic solvent. The black pigment was contained in a total of 10.1% by weight in the polyimide precursor composition.

### Example 1-2

A polyimide precursor composition was prepared in the same manner as Example 1-1 above except that a black pigment containing bituminous coal (6.6% by weight) and perylene black (4.5% by weight) was used instead of the black pigment containing bituminous coal (6.6% by weight) and perylene black (3.5% by weight) of Example 1-1. The black pigment was contained in a total of 11.1% by weight in the polyimide precursor composition.

### Example 1-3

A polyimide precursor composition was prepared in the same manner as Example 1-1 above except that a black pigment containing bituminous coal (6.6% by weight) and perylene black (5.5% by weight) was used instead of the black pigment containing bituminous coal (6.6% by weight) and perylene black (3.5% by weight) of Example 1-1. The black pigment was contained in a total of 12.1% by weight in the polyimide precursor composition.

### Example 1-4

A polyimide precursor composition was prepared in the same manner as Example 1-1 above except that a black pigment containing bituminous coal (6.6% by weight) and perylene black (6.5% by weight) was used instead of the black pigment containing bituminous coal (6.6% by weight) and perylene black (3.5% by weight) of Example 1-1. The black pigment was contained in a total of 13.1% by weight in the polyimide precursor composition.

The components and amounts of the polyimide precursor compositions prepared according to Examples 1-1 to 1-4 are summarized in Table 1 below (here, the percentage by weight (wt %) of the black pigment refers to the amount (content) in the polyimide precursor composition).

TABLE 1

| | Polyimide precursor composition | | | | | | | |
|---|---|---|---|---|---|---|---|---|
| | Polyamic acid solution | | | | | Black pigment | | |
| | | | | Diamine | | | | Total |
| | Dianhydride | | | (mol %) | | Bituminous | Perylene | weight % |
| | (mol %) | | | | m- | coal | black | of black |
| | PMDA | BTDA | BPDA | PPD | tolidine | (wt %) | (wt %) | pigment |
| Example 1-1. | 35 | 33 | 32 | 66 | 34 | 6.6 | 3.5 | 10.1 |
| Example 1-2. | 35 | 33 | 32 | 66 | 34 | 6.6 | 4.5 | 11.1 |
| Example 1-3. | 35 | 33 | 32 | 66 | 34 | 6.6 | 5.5 | 12.1 |
| Example 1-4. | 35 | 33 | 32 | 66 | 34 | 6.6 | 6.5 | 13.1 |

### Comparative Example 1: Preparation of Polyimide Precursor Composition

### Comparative Example 1-1 (without Containing Black Pigment)

As a polyamic acid solution polymerization process, 408.62 g of dimethylformamide (DMF) as a solvent was added to a 500 mL reaction vessel under a nitrogen atmosphere. A temperature was set to 25° C., PPD (66 mol %) and m-tolidine (34 mol %) were added as diamine monomers, stirred for about 30 minutes to confirm that the monomers were dissolved, and then PMDA (35 mol %), BTDA (33 mol %), and BPDA (32 mol %) were added as dianhydride monomers, and stirred to react until there was no change in viscosity, thereby obtaining a polyamic acid solution.

### Comparative Example 1-2 (Containing Only Bituminous Coal as Black Pigment)

A polyimide precursor composition was prepared in the same manner as Example 1-1 above except that a black pigment containing only bituminous coal (6.6% by weight) was used instead of the black pigment containing bituminous coal (6.6% by weight) and perylene black (3.5% by weight) of Example 1-1. The black pigment was contained in a total of 6.6% by weight in the polyimide precursor composition.

### Comparative Example 1-3 (Containing Bituminous Coal and Carbon Black as Black Pigments)

A polyimide precursor composition was prepared in the same manner as Example 1-1 above except that a black pigment containing bituminous coal (6.6% by weight) and carbon black (2.5% by weight) was used instead of the black pigment containing bituminous coal (6.6% by weight) and perylene black (3.5% by weight) of Example 1-1. The black pigment was contained in a total of 9.1% by weight in the polyimide precursor composition.

### Comparative Example 1-4 (Containing Only Perylene Black as Black Pigment)

A polyimide precursor composition was prepared in the same manner as Example 1-1 above except that a black pigment containing only perylene black (2.5% by weight) was used instead of the black pigment containing bituminous coal (6.6% by weight) and perylene black (3.5% by weight) of Example 1-1. The black pigment was contained in a total of 2.5% by weight in the polyimide precursor composition.

### Comparative Example 1-5 (Containing Only Perylene Black as Black Pigment)

A polyimide precursor composition was prepared in the same manner as Example 1-1 above except that a black pigment containing only perylene black (4.58 by weight) was used instead of the black pigment containing bituminous coal (6.6% by weight) and perylene black (3.5% by weight) of Example 1-1. The black pigment was contained in a total of 4.58 by weight in the polyimide precursor composition.

The components and amounts of the polyimide precursor compositions prepared according to Comparative Examples 1-1 to 1-5 are summarized in Table 2 below.

TABLE 2

| | Classification | | | | | | | | |
|---|---|---|---|---|---|---|---|---|---|
| | Polyamic acid solution | | | | | Black pigment | | | |
| | | | | Diamine | | | | | Total |
| | Dianhydride | | | (mol %) | | Bituminous | Perylene | Carbon | weight % |
| | (mol %) | | | | m- | coal | black | black | of black |
| | PMDA | BTDA | BPDA | PPD | tolidine | (wt %) | (wt %) | (wt %) | pigment |
| Comparative | 35 | 33 | 32 | 66 | 34 | — | — | — | 0 |
| Example 1-1 | | | | | | | | | |
| Comparative | 35 | 33 | 32 | 66 | 34 | 6.6 | — | — | 6.6 |
| Example 1-2 | | | | | | | | | |
| Comparative | 35 | 33 | 32 | 66 | 34 | 6.6 | — | 2.5 | 9.1 |
| Example 1-3 | | | | | | | | | |
| Comparative | 35 | 33 | 32 | 66 | 34 | — | 2.5 | — | 2.5 |
| Example 1-4 | | | | | | | | | |
| Comparative | 35 | 33 | 32 | 66 | 34 | — | 4.5 | — | 4.5 |
| Example 1-5 | | | | | | | | | |

### Example 2: Manufacture of Black Polyimide Film

### Example 2-1

The polyimide precursor composition prepared in Example 1-1 was cast on a SUS plate (100SA, Sandvik) to a thickness of 70 μm using a doctor blade and dried at a temperature range of 100° C. to 200° C. Next, the film was peeled from the SUS plate, fixed to a pin frame, and transferred to a high-temperature tenter machine. The film was heated from 200° C. to 600° C. in a high-temperature tenter, cooled to 25° C., and then separated from the pin frame, thereby manufacturing a black polyimide film containing 6.68 by weight of bituminous coal and 3.5% by weight of perylene black based on the total weight of the polyimide film, having a thickness of 12.5±0.5 μm.

### Example 2-2

A black polyimide film containing 6.6% by weight of bituminous coal and 4.5% by weight of perylene black based on the total weight of the polyimide film was manufactured in the same manner as Example 2-1 above, except that the polyimide precursor composition prepared in Example 1-2 was used instead of the polyimide precursor composition in Example 1-1.

### Example 2-3

A black polyimide film containing 6.6% by weight of bituminous coal and 5.5% by weight of perylene black based on the total weight of the polyimide film was manufactured in the same manner as Example 2-1 above, except that the polyimide precursor composition prepared in Example 1-3 was used instead of the polyimide precursor composition in Example 1-1.

### Example 2-4

A black polyimide film containing 6.6% by weight of bituminous coal and 6.5% by weight of perylene black based on the total weight of the polyimide film was manufactured in the same manner as Example 2-1 above, except that the polyimide precursor composition prepared in Example 1-4 was used instead of the polyimide precursor composition in Example 1-1.

### Comparative Example 2: Manufacture of Black Polyimide Film

### Comparative Example 2-1 (without Containing Black Pigment)

A polyimide film was manufactured in the same manner as Example 2-1 above, except that the polyimide precursor composition prepared in Comparative Example 1-1 was used instead of the polyimide precursor composition of Example 1-1. The polyimide film of Comparative Example 2-1 did not contain a black pigment.

### Comparative Example 2-2 (Containing Only Bituminous Coal as Black Pigment)

A black polyimide film containing 6.6% by weight of bituminous coal based on the total weight of the polyimide film was manufactured in the same manner as Example 2-1 above, except that the polyimide precursor composition prepared in Comparative Example 1-2 was used instead of the polyimide precursor composition of Example 1-1.

### Comparative Example 2-3 (Containing Bituminous Coal and Carbon Black as Black Pigments)

A black polyimide film containing 6.6% by weight of bituminous coal and 2.5% by weight of carbon black based on the total weight of the polyimide film was manufactured in the same manner as Example 2-1 above, except that the polyimide precursor composition prepared in Comparative Example 1-3 was used instead of the polyimide precursor composition of Example 1-1.

### Comparative Example 2-4 (Containing Only Perylene Black as Black Pigment)

A black polyimide film containing 2.5% by weight of perylene black based on the total weight of the polyimide film was manufactured in the same manner as Example 2-1 above, except that the polyimide precursor composition prepared in Comparative Example 1-4 was used instead of the polyimide precursor composition of Example 1-1.

### Comparative Example 2-5 (Containing Only Perylene Black as Black Pigment)

A black polyimide film containing 4.5% by weight of perylene black based on the total weight of the polyimide film was manufactured in the same manner as Example 2-1 above, except that the polyimide precursor composition prepared in Comparative Example 1-5 was used instead of the polyimide precursor composition of Example 1-1.

### Experimental Examples

### Experimental Example 1. Gloss Evaluation

Gloss was measured according to the ASTM D523 method at an angle of 60 degrees using a gloss meter (PG-IIM, NIPPON DENSHOKU), and results thereof are shown in Table 3 below.

### Experimental Example 2. Transmittance Evaluation

Transmittance was measured according to the ASTM D1003 method in the visible light region using a transmittance measurement device (ColorQuesetXE, HunterLab), and results thereof are shown in Table 3 below.

### Experimental Example 3. Dielectric Constant (Dk) Evaluation

The dielectric constant at 10 s measured using Keysight's SPDR meter, and results thereof are shown in Table 3 below.

### Experimental Example 4. Dielectric Dissipation Factor (Df)

The dielectric dissipation factor (Df) was measured by leaving the flexible metal-clad laminate for 72 hours using the Agilent 4294A impedance analyzer, and results thereof are shown in Table 3 below.

TABLE 3

| | Polyimide | Trans- | | Dielectric | Dielectric |
|---|---|---|---|---|---|
| Polyimide | precursor | mittance | Gloss | constant | dissipation |
| film | composition | (%) | (60°) | (Dk) | factor (Df) |
| Example 2-1 | Example 1-1 | 0.10 | 35.1 | 3.61 | 0.00852 |
| Example 2-2 | Example 1-2 | 0.06 | 36.3 | 3.70 | 0.00848 |
| Example 2-3 | Example 1-3 | 0.01 | 34.7 | 3.73 | 0.00878 |
| Example 2-4 | Example 1-4 | 0.00 | 31.2 | 3.72 | 0.00906 |
| Comparative | Comparative | 65.5 | 176 | 3.60 | 0.00395 |
| Example 2-1 | Example 1-1 | | | | |
| Comparative | Comparative | 2.21 | 17 | 3.56 | 0.00444 |
| Example 2-2 | Example 1-2 | | | | |
| Comparative | Comparative | 0.07 | 42 | 4.61 | 0.03082 |
| Example 2-3 | Example 1-3 | | | | |
| Comparative | Comparative | 0.91 | 142 | 3.62 | 0.00667 |
| Example 2-4 | Example 1-4 | | | | |
| Comparative | Comparative | 0.62 | 135 | 3.64 | 0.00701 |
| Example 2-5 | Example 1-5 | | | | |

Referring to Table 3, the black polyimide film of the present invention simultaneously satisfied all conditions, transmittance of 0.1% or less, gloss of 50 or less, dielectric constant of 4.0 or less, and dielectric dissipation factor of 0.01 or less.

However, Comparative Example 2-1 without containing black pigment, and Comparative Examples 2-4 and 2-5 containing only perylene black as a black pigment, showed very high transmittance and gloss, and Comparative Example 2-2 containing only bituminous coal as a black pigment, showed a very high transmittance of 2% or more.

In addition, Comparative Example 2-3 containing bituminous coal and carbon black as black pigments showed significantly high dielectric constant and dielectric dissipation factor of 4.61 and 0.03082, respectively.

In the specification, details capable of being sufficiently recognized and inferred by those skilled in the art of the present invention are omitted, and various modifications can be made within the scope that does not change the technical spirit or essential configuration of the present invention other than the specific examples described in the present specification. Therefore, the present invention may be practiced in other ways than specifically described and exemplified herein, which can be understood by those skilled in the art.

1. A black polyimide film manufactured by imidizing a polyamic acid obtained from dianhydride monomers and diamine monomers, the black polyimide film comprising: a black pigment containing bituminous coal and perylene black.

2. The black polyimide film of claim 1, wherein the film comprises 3 to 15% by weight of bituminous coal and 2 to 15% by weight of perylene black based on the total weight of the film.

3. The black polyimide film of claim 1, wherein the film comprises 5 to 10% by weight of bituminous coal and 3 to 10% by weight of perylene black based on the total weight of the film.

4. The black polyimide film of claim 1, wherein the bituminous coal has an average particle diameter (D50) of 0.5 to 10 μm.

5. The black polyimide film of claim 1, wherein the perylene black has an average particle diameter (D50) of 100 to 1200 nm.

6. The black polyimide film of claim 1, wherein the dianhydride monomer is at least one selected from the group consisting of pyromellitic dianhydride (PMDA), oxydiphthalic dianhydride (ODPA), 3,3′,4,4′-biphenyltetracarboxylic dianhydride (s-BPDA), 2,3,3′,4′-biphenyltetracarboxylic dianhydride (a-BPDA), diphenylsulfone-3,4,3′,4′-tetracarboxylic dianhydride (DSDA), bis(3,4-dicarboxyphenyl) sulfide dianhydride, 2,2-bis(3,4-dicarboxyphenyl)-1,1,1,3,3,3-hexafluoropropane dianhydride, 2,3,3′,4′-benzophenone tetracarboxylic dianhydride, 3,3′,4,4′-benzophenonetetracarboxylic dianhydride (BTDA), bis(3,4-dicarboxyphenyl) methane dianhydride, 2,2-bis(3,4-dicarboxyphenyl)propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3,6,7-naphthalene tetracarboxylic acid dianhydride, 1,4,5,8-naphthalenetetracarboxylic dianhydride and 4,4′-(2,2-hexafluoroisopropylidene)diphthalic acid dianhydride.

7. The black polyimide film of claim 1, wherein the diamine monomer is at least one selected from the group consisting of paraphenylenediamine (PPD), metaphenylenediamine, 3,3′-dimethylbenzidine, 2,2′-dimethylbenzidine, 2,4-diaminotoluene, 2,6-diaminotoluene, 3,5-diaminobenzoic acid (DABA), 4,4′-oxydianiline (ODA), 4,4′-diaminodiphenylmethane, 3,3′-dimethyl-4,4′-diaminobiphenyl, 2,2′-dimethyl-4,4′-diaminobiphenyl(m-tolidine), 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl) sulfide, 4,4′-diaminobenzanilide, 3,3′-dimethoxybenzidine, 2,2′-dimethoxybenzidine, 3,3′-diaminodiphenyl ether, 3,4′-diaminodiphenyl ether, 4,4′-diaminodiphenyl ether, 3,3′-diaminodiphenylsulfide, 3,4′-diaminodiphenylsulfide, 4,4′-diaminodiphenylsulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1, 1,1,3,3,3-hexafluoropropane, 2,2-bis(4-aminophenyl)-1,1,1,3,3,3-hexafluoropropane, 3,3′-diaminodiphenylsulfoxide, 3,4′-diaminodiphenylsulfoxide, 4,4′-diaminodiphenylsulfoxide, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene (TPE-R), 1,4-bis(3-aminophenoxy)benzene (TPE-Q), 1,3-bis(3-aminophenoxy)-4-trifluoromethylbenzene, 3,3′-diamino-4-(4-phenyl) phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane (BAPP), 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, and 2,2-bis[4-(4-aminophenoxy)phenyl]-1,1,1,3,3,3-hexafluoropropane.

8. The black polyimide film of claim 1, wherein the dianhydride monomer is at least one selected from the group consisting of pyromellitic dianhydride (PMDA), oxydiphthalic dianhydride (ODPA), 3,3′,4,4′-biphenyltetracarboxylic dianhydride (s-BPDA), 2,3,3′,4′-biphenyltetracarboxylic dianhydride (a-BPDA), and 3,3′,4,4′-benzophenonetetracarboxylic dianhydride (BTDA), and
the diamine monomer is at least one selected from the group consisting of paraphenylenediamine (PPD), 2,2′-dimethyl-4,4′-diaminobiphenyl(m-tolidine), 4,4′-oxydianiline (ODA), and 1,3-bis(4-aminophenoxy)benzene (TPE-R).

9. The black polyimide film of claim 1, wherein the dianhydride monomer contains 20 to 80 mol % of pyromellitic dianhydride (PMDA); 10 to 50 mol % of 3,3′,4,4′-biphenyltetracarboxylic dianhydride (s-BPDA) or 2,3,3′,4′-biphenyltetracarboxylic dianhydride (a-BPDA); and 10 to 50 mol % of 3,3′,4,4′-benzophenonetetracarboxylic dianhydride (BTDA), and
the diamine monomer contains 10 to 80 mol % of paraphenylenediamine (PPD); and 20 to 90 mol % of 2,2′-dimethyl-4,4′-diaminobiphenyl(m-tolidine).

10. The black polyimide film of claim 1, wherein the film has a thickness of 5 to 100 μm.

11. The black polyimide film of claim 1, wherein
a transmittance in the visible light region is 0.2% or less,
a gloss (60°) is 50 or less,
a dielectric constant (Dk) is 4.0 or less, and
a dielectric dissipation factor (Df) is 0.01 or less.

12-17. (canceled)

18. The black polyimide film of claim 1, the film contains 5 to 30% by weight of the black pigment based on the total weight of the film.

19. The black polyimide film of claim 1, the molar ratio of the diamine monomer to the dianhydride monomer is 0.5 to 2 equivalents.

20. The black polyimide film of claim 1, wherein
a transmittance in the visible light region is 0.1% or less,
a gloss (60°) is 40 or less,
a dielectric constant (Dk) is 3.7 or less, and
a dielectric dissipation factor (Df) is 0.01 or less.

21. A manufacturing method of a black polyimide film comprising:
(1) polymerizing a polyamic acid solution from at least one dianhydride monomer and at least one diamine monomer;
(2) preparing a polyimide precursor composition by mixing the polyamic acid solution with a black pigment containing bituminous coal and perylene black; and
(3) imidizing the polyimide precursor composition by forming a film on a support and heat-treating the film.

22. The manufacturing method of claim 21, comprising, before Step (2), milling with a milling machine to prepare bituminous coal having an average particle diameter (D50) of 0.5 to 10 μm and perylene black having an average particle diameter (D50) of 100 to 1200 nm, respectively.

23. The manufacturing method of claim 21, wherein in Step (2), the black pigment is obtained by dispersing bituminous coal and perylene black in an organic solvent.

24. The manufacturing method of claim 23, wherein the organic solvent is at least one selected from the group consisting of N-methylformamide, N,N′-dimethylformamide (DMF), N-methylformanilide, N,N′-dimethylacetamide (DMAC), N-methyl-pyrrolidone (NMP), propylene glycol methyl ether acetate (PGMEA), ethyl glycol acetate, propylene glycol monomethyl ether acetate, dimethyl sulfoxide, benzyl ethyl ether, dihexyl ether, and acetylacetone.

25. The manufacturing method of claim 21, wherein the polyamic acid solution has a viscosity in the range of 20,000 to 400,000 cP as measured under conditions of a temperature of 23° C. and a shear rate of 1 s-1.

26. A coverlay comprising the black polyimide film according to claim 1.
